(19) United States
(12) Patent Application Publication
(10) Pub. No.: US 2017/0050200 A1
(43) Pub. Date: Feb. 23, 2017

(54) Multipurpose Dispenser

(71) Applicants: Ian George Thompson, Bronx, NY (US); Andrew Thompson, Bronx, NY (US)

(72) Inventors: Ian George Thompson, Bronx, NY (US); Andrew Thompson, Bronx, NY (US)

(21) Appl. No.: 14/833,120

(22) Filed: Aug. 23, 2015

(51) Int. Cl. B05B 11/00; A45D 34/00; A47K 5/12; A47K 10/36; B65D 83/00; B65D 83/08

(52) U.S. Cl. CPC B05B 11/0037; B65D 83/00; B65D 83/0805; A47K 5/1201; A47K 10/3643; A45D 34/00; A45D 2034/007

(57) ABSTRACT

Multipurpose Dispenser is discreet and practical. It will allow people to use the toilet wherever, whenever and feel comfortable and confident to return to their daily activities. It will encourage young adults, teenagers and pre-teens to use the toilet more often while practicing good hygiene. They can carry the Multipurpose Dispenser discreetly when going to the restroom, reduce anxiety, build confidence and feel refreshed. They can also carry the Multipurpose Dispenser all day in their pant pocket, bookbags or jacket while working or tending to errands.

### CROSS-REFERENCE TO RELATED APPLICATIONS

Not Applicable or The present application relates and claims priority to U.S. provisional patent application No. 62/070,366 filed on Aug. 23, 2014.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

Field of the Invention

The present invention relates generally to a multipurpose dispenser, more particularly the present invention relates to the multipurpose dispenser that can be used in restrooms and toilets.

Description of the Related Art

Many people fear using public restrooms or any toilet other than their own. People worry about being exposed as well as contracting a disease. Another concern is the ability to be discreet. Some people feel embarrassed when others know they went to the restroom, for example using the restroom in a small doctor's office and have to come back to sit next to someone. The anxiety comes from not feeling clean, even if they use plenty of tissue it still does not seems like enough to feel clean. Because of this insecurity people have developed the habit of holding their feces which herein we will refer to as “holding it up”, so not to use the toilet until they arrive home or somewhere comfortable. This is unhealthy especially if it has developed into a long term habit. Below are a list of health problems that can arise from “holding it up”.
Could lead to sever constipation.
Create toxins which is bad for your organs.
If you “hold it up” for too long more toxins are released. Eventually some of the toxins will get reabsorbed back into the bloodstream.
Kill healthy cancer cells and eventually turn them into cancer.
Can lead to straining and bloating.
Can cause anal fissures (tears in the skin around the anus) which is caused by straining.
Can lead to hemorrhoids.
Can lead to serious damage to your internal sphincter: The muscle in your rectum that relaxes to allow for quick and easy bowel movements which eventually can cause the internal sphincter to stop relaxing entirely.
If you “hold it up” harmful bacteria in your intestine will have time to multiply. Your immune system has to work harder to control these germs. Your liver has increased workload of detoxifying the toxins produced by these harmful bacteria. You will have a weaker body and get tired easily.
In the long run it may lead to all sorts of intestinal problems including colon cancer.

Multipurpose Dispenser is discreet and practical. It will allow people to use the toilet wherever, whenever and feel comfortable and confident to return to their daily activities. It will encourage young adults, teenagers and pre-teens to use the toilet more often while practicing good hygiene. They can carry the Multipurpose Dispenser discreetly when going to the restroom, reduce anxiety, build confidence and feel refreshed. They can also carry the Multipurpose Dispenser all day in their pant pocket, book bags or jacket while working or tending to errands.

Because it can dispense various types of materials from one product allowing portability, convenience and practicality above anything on the market. The Multipurpose Dispenser used as a hygiene unit would prevent the consumer from carrying bulky items. A man's pockets may already contain items such as a wallet, keys and cell phone and would not be possible for most men to add a pack of personal wipes, a bottle of disinfectant spray, moisturizer lotion and a bottle of hand sanitizer to his pant pockets. The Multipurpose Dispenser can fit all of these materials into one product and because The Multipurpose Dispenser is not limited to size and shape it can be available to fit in a pant pocket or a small handbag.

The problem with other devices or systems in the field of our invention is that the other products only serve a single purpose while the Multipurpose Dispenser allows multiple materials to be dispensed from a single unit. Other devices or systems don't work well because the quantity of the products that one would have to carry on their person is not practical.

Our invention improves on existing devices or systems by combining several products into one unit we give the consumer the ability to increase confidence with a readiness one product alone could not offer. The Multipurpose Dispenser may preferably (but not necessarily) have a wide range of multimedia capabilities.

### BRIEF SUMMARY OF THE INVENTION

The Multipurpose Dispenser is a collective of dispenser's that form a single product that can dispense multiple material's from one unit.

### DESCRIPTION OF THE DRAWINGS

For a more complete understanding of the present invention, reference is now made to the following descriptions:

FIG. 1 show all the components of the present invention.

FIG. 2 show the mail thread.

FIG. 3 show the Inner track, Outer track and Case track.

FIG. 4 show an alternative arrangement and design for the present invention and show its 3 parts.

FIG. 5 show an alternative arrangement and design for the present invention.

### REFERENCE NUMERALS IN THE DRAWINGS

For a more complete understanding of the present invention parts, reference is now made to the following descriptions:
1. Complete unit.
2. Main Body.
3. Dispenser A.
4. Dispenser B.
5. Dispenser C.
6. Control Device.
7. Track Ring.
8. Inner Sleeve.
9. Outer sleeve.
10. Case Sleeve.
11. Material/s.
12. Material pass through opening.
13. Cutting Edge.
14. Closure device.
15. Male thread.
16. Inner Track.
17. Outer Track.
18. Case Track.
19. Neck.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

The Multipurpose Dispenser can used in multiple industries such as Personal hygiene, Beauty, Medical fields, Automotive, Film, C etc. . . .
Example: Personal—Disinfectant, Air neutralizer, personal wipes, sanitizer, moisturizer lotion etc. . . .
Example: Beauty—Hair spritz, facial cleansing wipes, makeup remover wipes, moisturizer lotion, nail polish remover, foundation etc. . . .
Example: Medical—Peroxide, rubbing alcohol, disinfecting wipes, antiseptic wipes, eczema lotions, other medical creams and lotions etc. . . .
Example: Automotive—Cleaning solution, Hand cleaners, waxes, facial & hand wipes etc. . . .
Example: Film—Solutions and wipes for cleaning sensitive electronic equipment

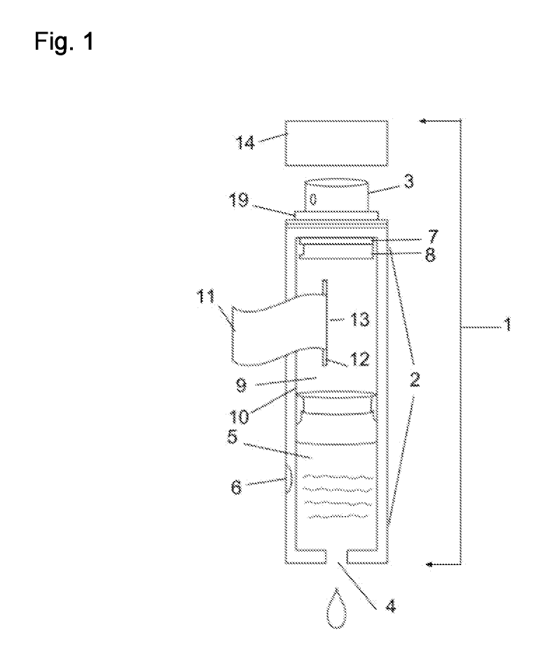

Referring to FIG. 1 so we can understand how the present invention work we have to explain the components of the present invention as the following:

The complete unit 1 contains all components of the product. The main body 2 is the principal mass of the dispensers. The main body 2 is divided by suitable means to create multiple dispensers and may also help in the aid of the creations of other dispensers such as dispenser B 4.

Dispenser A 3 have the capabilities to dispense a wide variety of materials, including without limitations, wipes, moistened piece of paper, cloth or other material saturated with cleansing ingredients for any purpose, liquids, lotions, creams, gels, paste, peroxide, powder, tools, food and beverages.

Dispenser B 4 consist, including without limitations, of Inner sleeve 8, material 11, outer sleeve 9, cutting edge 13, material pass through opening 12. Dispenser B 4 has the capabilities to dispense any material, including without limitations, wipes; moistened piece of paper, cloth or other material saturated with cleansing ingredients for any purpose, liquids, lotions, creams, gels, paste, peroxide, powder, tools, food and beverages.

Dispenser C 5 has the capabilities to dispense any material, including without limitations, wipes; moistened piece of paper, cloth or other material saturated with cleansing ingredients for any purpose, liquids, lotions, creams, gels, paste, peroxide, powder, tools, food and beverages.

Control device 6 may include, but not limited to, knobs, buttons, valves, computers (hardware, software) and various types of switches to any location on the Multipurpose Dispenser to enhance the product and it's capabilities. Control device 6 allows the consumer to gain access to various elements, components and materials.

Track Ring 7 holds the sleeves in place as well as aid in the function of the sleeves operation. It provides a seal to prevent any Materials or liquids from escaping. It also may offer a means to close and or seal the product. The Track Ring 7 is not defined by the amount of tracks on the component it may have one track or more than one track including but not limited to the Inner Track 16.

Inner Sleeve 8 supports material/s 11 on its exterior and aids in the function that allows the consumer to utilize the material.

Outer Sleeve 9 may have cut outs in a manner, including without limitations, for materials to pass through, control device 6 and cutting edge 13 and or consist of any other element to optimize product functionality.

The Case Sleeve 10 house the components for the of the Multipurpose Dispenser which may include closures 14.

Material/s 11, including without limitations, wipes; moistened piece of paper, cloth or other material saturated with cleansing ingredients for any purpose, liquids, lotions, creams, gels, paste, peroxide, powder, tools, food and beverages.

Material Pass Through Opening 12 allows Material/s 11 to be utilize by the consumer and its placement on the unit is, including without limitations, to Case Sleeve 10 and all the dispensers.

Cutting edge 13 is included on the Outer Sleeve 9 which is used to cut, tear or rip Material/s 11 and aids in the ease of dispensing Material/s 11.

The Closure device 14 used to close or seal the Multipurpose Dispenser, including but not limited to, screw top, snap on, spray bottles, aerosol spray, pour spouts, triggers, sprayer cap, shifting devices, child resistant, lids, plugs etc. Closure device 14 will need a means of attaching to the Multipurpose Dispenser with sufficient security by, including without limitations, threads, lugs, hinges, locks, adhesives, etc.

Multipurpose Dispenser may be used as a hygiene dispenser. As a hygiene dispenser it will dispense disinfectant material, personal wipes and sanitizer solution.

In the present invention, Dispenser A 3 will dispense: Disinfectant spray. Dispenser B 4 will dispense: Personal wipes. Dispenser C 5 will dispense: Sanitizer solution.

The Multipurpose Dispenser work by the consumer unlocking or removing the closure device 14. The consumer depresses Control Device 6 to release materials 11 from Dispenser A 3. The consumer twist the case sleeve 10 and align it with the materials pass through opening 12, thus allowing access to the personal wipes, the materials 11, which the consumer pulls and tears via cutting edge 13.

This is possible by the Inner Sleeve 8 in which the Material/s 11 is wrapped on its exterior. The Material/s 11 unlock, turn/spin when consumer pulls on the materials 11.

The cutting edge 13 located on the Outer Sleeve 9 allows the consumer to tear Material/s 11 to disconnect from product.

Upon completion of use of the Multipurpose Dispenser the consumer turns the product to Dispenser C 5 opens the closure device 14 and depress the release button which dispense the sanitizer solution.

The Complete Unit 1 and all components is made via a mold. The Multipurpose Dispenser measures 16 cm in length, 2 cm in depth and 3.5 cm in width.

The Multipurpose Dispenser is rectangular in shape. The Multipurpose Dispenser may be created in a variety of shapes, textures, sizes and weight.

The Inner Sleeve 8 is 6 cm in length. Materials 11 adheres and wraps around the exterior of the Inner Sleeve 8.

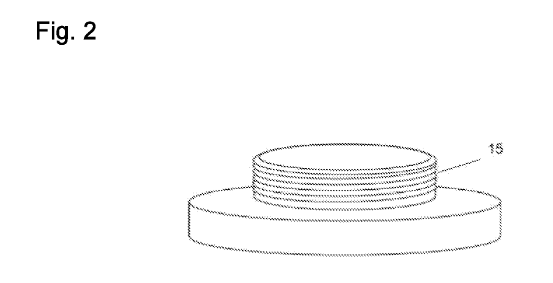

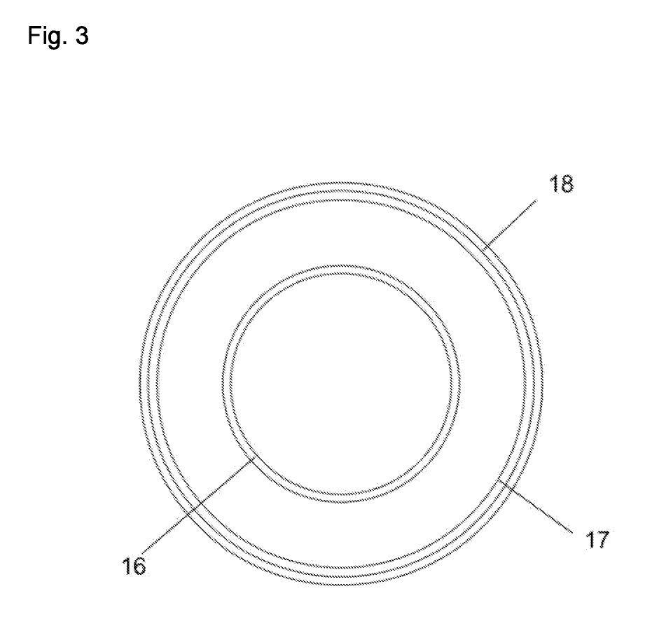

Referring to FIG. 2 and FIG. 3 The Track Ring 7 may have male thread 15 on its exterior for a closure device 14 to screw on and or seal the product. The framework on the underside of the Track Ring 7 is made of three tracks with grooves The three tracks, includes but not limited to, the following: The Inner Track 16, The Outer Track 17 and The Case Track 18.

Both the Outer Track 17 and the Case Track 18 have stop notches in its grooves to prevent or restrict movement while the Inner Track 16 may have no groove restrictions which allows the Inner Sleeve 8 to spin freely.

Referring to FIG. 1 a Track Ring 7 is slipped over the Main body 2 from the direction of Dispenser C 5 and press to the neck 19 . . .

The Track Ring 7 is fused (to become united or blended) with Dispenser C 5 creating a seal at the interface.

The Inner Sleeve 8 with Material/s 11 attached slips over Dispenser A and slides . . . into the Inner Track 16 of the Track Ring 7.

The Outer Sleeve 9 is equipped with cutting edge 13. The Outer Sleeve 9 slips over Dispenser A 3 and slides into the Outer Track 17 of the Track Ring 7.

The Outer Sleeve 9 and Material pass through opening 12, is aligned with the Material 11 on the Inner Sleeve 8 to allow the consumer to gain access.

The Case Sleeve 10 slips over Dispenser A 3 and slides into the Case Track of the Track Ring 7.

A Track Ring 7 slips over the Main body 2 from the direction of Dispenser A 3 and pressed until it connects to the Inner Sleeve 8 Outer Sleeve 9 and Case Sleeve 10 until all sleeves are seated in it's appropriate tracks.

Dispenser A 3 and Dispenser C 5 are filled with materials 11 or liquid. The Multipurpose Dispenser is closed and or sealed.

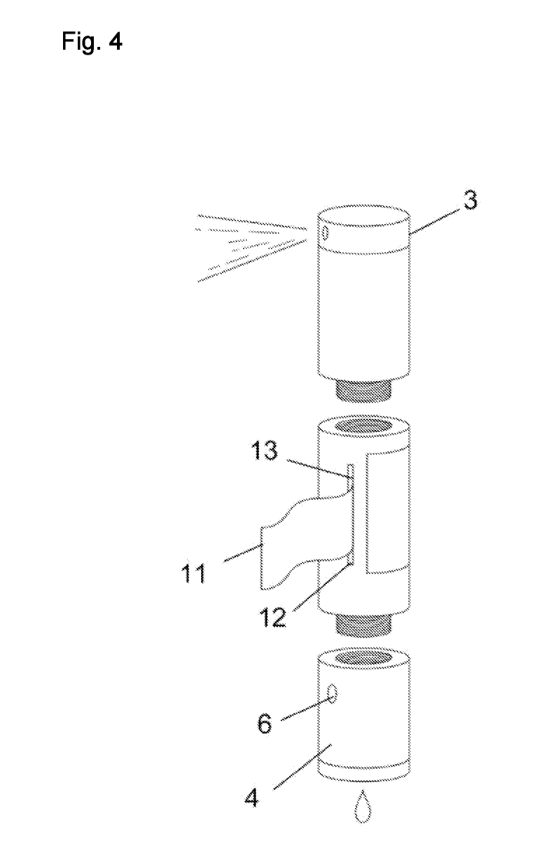

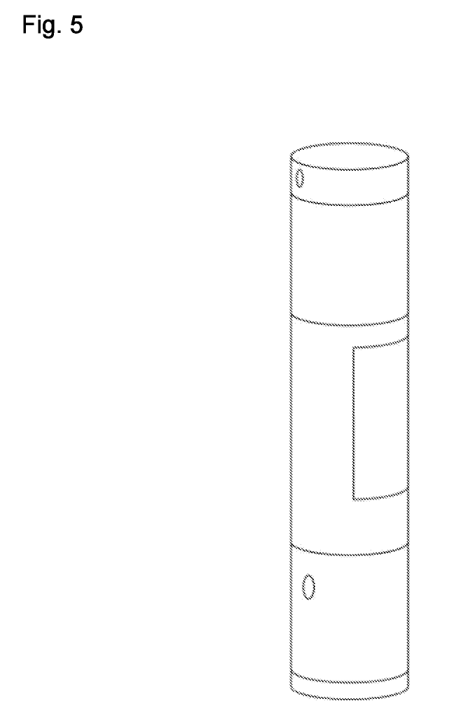

Referring to FIG. 4 and FIG. 5 the Multipurpose Dispenser can be made with the same functions but in a different arrangement and design.

The Multipurpose Dispenser can be made with three compartments which uses a cartridge or any suitable method to interchange components for refilling purpose when product is depleted.

The Multipurpose Dispenser is not limited to a specific arrangement or amount of dispensers. The dispensers can be arrange in any order best suited to enhance the functionality of the product.

The Multipurpose Dispenser can be made from various materials, including without limitations, different types of plastics, aluminum, variety of metals, gold, silver, platinum etc. . . . . Attributes, including without limitations, switches and knobs is not limited to one component of the multipurpose dispenser and can be arranged anywhere on the multipurpose dispenser to enhance the Multipurpose Dispenser.

Element's can be added to enhance unit are a light source, automatic control device for example: Consumer depress a button for personal wipes and cylinder spins automatically dispensing wipes. Dual or multi-lower & upper dispensers for additional materials such as a combination of sanitizer and lotion. Other elements, including but not limited to, clips, bearings or springs may be added to hold dispensers in place, allowing elements to turn or make the product function efficiently. Multimedia in various forms can be added to the Multipurpose Dispenser. USB ports, SD cards, various control device and various input and output device's. Numerous types of straps can be added for to aid in the readiness and functionality of the product, for example a strap for the consumer to carry the product on a belt.

The component's of the Multipurpose Dispenser can be shuffled by changing the shape, texture, weight and size of the components, including, without limitations, changing the components within the unit. The Multipurpose Dispenser can be made to preferably (But not necessarily) house materials of all types, including but not limited to, liquids, lotions, creams, gels, paste, peroxide, powder and wipes of all types such as personal, facial, baby.

1. A multipurpose dispenser with the following advantages, features and functions:
a multipurpose dispenser to allow people to use the toilet wherever and feel comfortable and confident to return to their daily activities, It will encourage young adults, teenagers and pre-teens to use the toilet more often while practicing good hygiene, people can carry the multipurpose dispenser discreetly when going to the restroom, reduce anxiety, build confidence and feel refreshed;
a multipurpose dispenser can be used in personal hygiene like disinfectant, air neutralizer, personal wipes, sanitizer, moisturizer lotion etc;
a multipurpose dispenser can be used in beauty like hair spritz, facial cleansing wipes, makeup remover wipes, moisturizer lotion, nail polish remover, foundation etc;
a multipurpose dispenser can be used in medical fields like peroxide, rubbing alcohol, disinfecting wipes, antiseptic wipes, eczema lotions, other medical creams and lotions etc;
a multipurpose dispenser can be used in automotive like cleaning solution, hand cleaners, waxes, facial & hand wipes etc; and
a multipurpose dispenser can be used in film like solutions and wipes for cleaning sensitive electronic equipment.

2. A multipurpose dispenser comprising:
a complete unit that contains all components of the multipurpose dispenser;
a main body that is the principal mass of the dispensers, the main body is divided by suitable means to create multiple dispensers and may also help in the aid of the creations of other dispensers such as dispenser B;
dispenser A has the capabilities to dispense a wide variety of materials, including without limitations, wipes, moistened piece of paper, cloth or other material saturated with cleansing ingredients for any purpose, liquids, lotions, creams, gels, paste, peroxide, powder, tools, food and beverages;
dispenser B consist including without limitations of, Inner sleeve, material, outer sleeve, cutting edge, material pass through opening;
dispenser B has the capabilities to dispense any material, including without limitations, wipes, moistened piece of paper, cloth or other material saturated with cleansing ingredients for any purpose, liquids, lotions, creams, gels, paste, peroxide, powder, tools, food and beverages;
dispenser C has the capabilities to dispense any material, including without limitations, wipes, moistened piece of paper, cloth or other material saturated with cleansing ingredients for any purpose, liquids, lotions, creams, gels, paste, peroxide, powder, tools, food and beverages;
a control device may include, but not limited to, knobs, buttons, valves, computers (hardware, software) and various types of switches to any location on the multipurpose dispenser to enhance the product and it's capabilities, the control device allows the consumer to gain access to various elements, components and materials;
track ring holds the sleeves in place as well as aid in the function of the sleeves operation, the track ring provides a seal to prevent any Material/s or liquids from escaping, the track ring also may offer a means to close and or seal the product, the track ring is not defined by the amount of tracks on the component it may have one track or more than one track including but not limited to the inner track;
an inner sleeve supports material/s on its exterior and aids in the function that allows the consumer to utilize the material;
an outer sleeve may have cut outs in a manner, including without limitations, for materials to pass through, control device and cutting edge and or consist of any other element to optimize product functionality;
a case sleeve house the components for the of the multipurpose dispenser which may include closures;
material/s including without limitations, wipes; moistened piece of paper, cloth or other material saturated with cleansing ingredients for any purpose, liquids, lotions, creams, gels, paste, peroxide, powder, tools, food and beverages;
material pass through opening allows material/s to be utilize by the consumer and its placement on the unit is, including without limitations, to Case Sleeve and all the dispensers;
a cutting edge is included on the outer sleeve which is used to cut, tear or rip material/s and aids in the ease of dispensing material/s;
a closure device used to close or seal the multipurpose dispenser, including but not limited to, screw top, snap on, spray bottles, aerosol spray, pour spouts, triggers, sprayer cap, shifting devices, child resistant, lids, plugs etc, the closure device will need a means of attaching to the multipurpose dispenser with sufficient security by, including without limitations, threads, lugs, hinges, locks, adhesives, etc;
a male thread that is a helical structure used to convert between rotational and linear movement or force and may be the essential feature to allow it to be used as a fastener;
an inner track located on the underside of the track ring in a circular pattern structured as grooves that may have notches to restrict movement and allows the inner sleeve to be seated into it;
an outer track located on the underside of the track ring in a circular pattern structured as grooves that may have notches to restrict movement and allows the outer sleeve to be seated into it;
a case track located on the underside of the track ring in a circular structured as grooves that may have notches to restrict movement and allows the case sleeve to be seated into it; and
a neck that is a slender part near the top of a bottle or similar object.

3. The present multipurpose dispenser can be made with the same functions but in a different arrangement and design, the multipurpose dispenser can be made with three compartments which uses cartridges or any suitable method to interchange components for refilling purpose when product is depleted, the multipurpose dispenser is not limited to a specific arrangement or amount of dispensers, the dispensers can be arrange in any order best suited to enhance the functionality of the product, the multipurpose dispenser can be made from various materials, including without limitations, different types of plastics, aluminum, variety of metals, gold, silver, platinum etc, attributes, including without limitations, switches and knobs is not limited to one component of the multipurpose dispenser and can be arranged anywhere on the multipurpose dispenser to enhance the multipurpose dispenser, the component's of the multipurpose dispenser can be shuffled by changing the shape, texture, weight and size of the components, including, without limitations, changing the components within the unit, the multipurpose dispenser can be made to preferably (But not necessarily) house materials of all types, including but not limited to, liquids, lotions, creams, gels, paste, peroxide, powder and wipes of all types such as personal, facial, baby.
